(19) United States
(12) Patent Application Publication
(10) Pub. No.: US 2009/0165429 A1
(43) Pub. Date: Jul. 2, 2009

(54) Bale Bag Support and Method for Bagging Bales

(76) Inventor: Bruce Telleen, Monticello, IA (US)

Correspondence Address: Joseph W. Holland;Holland Law Office PLLC, PO Box 1840, Boise, ID, 83701-1840, US

(21) Appl. No.: 11/968,555

(22) Filed: Jan. 2, 2008

(51) Int. Cl. A01F 25/13; B65B 43/26

(52) U.S. Cl. 53/564; 53/459; 53/384.1

(57) ABSTRACT

A bale bag support device, system and method that provides for placement of a bale into a bale bag by maintaining a bale bag in an opened configuration employing a bale bag support device that includes a frame adapted for advancing motion, a bag support and a bale threshold attached to the frame that define a bale aperture through which bales may be placed onto a bale receiving area located on an inner surface of the bale bag beyond the bale threshold. The bale bagging system also includes a pick and place device for placing bales into the opened bale bag and which may also be employed to advance the bale bag support device a distance sufficient to create a bale receiving area located inside the bale bag beyond the bale threshold.

### BACKGROUND OF THE INVENTION

1. Technical Field

The present invention relates generally to devices and methods for handling feed and more particularly to a device for supporting a bale storage bag and a method for bagging baled forage crops.

2. Background

A variety of devices and methods have been devices for handling and storing forage crops. For instance, the prior art also discloses a variety of devices and methods for placing baled hay or other baled agricultural product in a tube or sheath. U.S. Pat. No. 6,513,307 to Lucas discloses a method for sheathing a bale that includes inserting a bale through a carrier, pushing the bale onto a sheath. U.S. Pat. No. 5,829,233 to Stirling discloses an apparatus for loading bales of agricultural products into a protective sheath. U.S. Pat. No. 5,425,221 to Pronovost, et al., discloses a device upon which bales of hay are successively loaded on the frame of a wheeled vehicle. A pusher plate pushes successive bales into the open-ended portion of a long plastic flexible tube. U.S. Pat. No. 5,398,487 to Inman, et al., discloses a machine for sheathing bales of material, such as farm crop products, into an elongated elastic bag.

The above devices rely on the reaction of the device that supports the carrier to the reverse motion of the member or element that pushes the bale into the sheath against the last bale placed in the sheath. Accordingly, it is the action of the loading mechanism or ram and the reaction of the device to that action that advances the device over a distance corresponding to the length of a bale as it is inserted through the carrier and into the sheath.

U.S. Pat. No. 5,220,772 to Koskela, et al., discloses a machine for sheathing bales of material such as hay, straw and the like. The machine has radially adjustable fingers to stretch a resilient sheath for the free insertion of the bales. As the device advances along a row of bales, a leading edge of the device picks or scoops the bales advancing them through a ring that supports an elastic sheath that contracts around the bales as the bales pass through the ring back onto the ground. The resilient sheath shrinks to fit closely to the contour of the bale.

Additionally, the prior art discloses devices and methods for bagging baled feed. U.S. Pat. No. 5,003,754 to van der Lely discloses a sheathing device for loading bales into an elongated, flexible bag. U.S. Pat. No. 4,945,715 to Brodrecht discloses a bale bagging apparatus for bagging round bales in tubes of plastic film. U.S. Pat. No. 4,888,937 to Glenn discloses a method and apparatus for facilitating bagging large round hay bales. The apparatus has a supporting frame that supports a large ring on which a large flexible folded plastic tube is mounted. By positioning a bale inside of the ring and then moving the apparatus, the bale is covered by the plastic tube. The process is repeated until the tube is filled with bales. U.S. Pat. No. 4,686,817 to Brodrecht, et al., discloses an apparatus for loading a row of round bales into an elongated plastic bag. U.S. Pat. No. 4,594,836 to Good discloses a transportable bagging apparatus for continual, sequential loading of individual bales of agricultural products such as grass, alfalfa, corn stalks, hay, etc., into plastic tubing.

In all of the above illustrations, the inventors teach devices and methods wherein a bale is set onto a ring connected to the bag support member and is then slid off the ring into the bag, pulling the bag from the ring and over the bale as the device that supports the ring is advanced. One problem with these devices and methods is found in a potential for tearing the bag as the bale slides from the ring and drops to the ground pulling the bag from the bag support member.

Additionally Brodrecht, Stirling, Pronovost, et al., Inman, et al., and Koskela, et al., all proclaim the desirability of maintaining either an air tight enclosure or an enclosure that traps a minimum amount of air within the sheath to achieve a desired moisture level.

Advantage may be found therefore in providing a bale bag support device and method that permits for the insertion of one or more bales through a bag support ring, setting the bales on the inside of the bag that is in contact with the ground, followed by advancing the bag support ring a distance substantially equal to a length of the bale.

Additional advantage may be found in a device and method that provides a means to promote air flow through the bag providing a controlled drying of the baled forage crop.

### SUMMARY OF THE INVENTION

The present invention is directed to a bale bag support device that includes a frame that is supported by and movable on wheels, skids or the like with respect to the ground or other surface upon which a bale bagging operation might take place. The bale bag support device frame includes a bag support frame about which a bag may be placed in a folded or bunched manner such that as the frame is moved with respect to the ground or other surface upon which the bale bagging operation is taking place, the length of the deployed bag is increased behind the bagging device to accommodate placement of additional bales within the bag. A bag support tray is attached to the frame and supports the lower portion of the bag and keeps it from dragging on the ground. A bale threshold is positioned above the bag support tray. In use, baled material is placed over the bale threshold onto a bale receiving area located beyond the bale threshold on an inner surface of the bag.

The present invention is also directed to a bale bagging system that employs the bale bag support device of the present invention in conjunction with a bale pick and place device, for instance a loader or lift that is adapted to pick bales for placement over the bale threshold onto a bale receiving area located beyond the bale threshold on an inner surface of the bag. The pick and place device is further adapted to provide one or more retractable bale bag support device engaging members that selectively engage and advance the bale bag support device to create a bale receiving area located beyond the bale threshold on an inner surface of the bag.

The present invention is also directed to a method for facilitating placement of a bale into a bale bag for storage on a surface that includes the steps of maintaining a bale bag in an opened configuration employing a bale bag support device that includes a frame adapted for advancing motion, a bag support and a bale threshold attached to the frame and defining an aperture through which a bale may be placed into the bale bag, picking and placing the bale in the bale bag onto a bale receiving area located on an inner surface of the bale bag beyond the bale threshold. The method of the present invention may also include engaging the bale bag support device with a pick and place device and advancing the bale bag support device a distance sufficient to create a bale receiving area located on an inner surface of the bale bag beyond the bale threshold.

### BRIEF DESCRIPTION OF THE FIGURES

FIG. 1 is a representative perspective view of a bale bag support device according to the present invention.

FIG. 2 is a representative perspective view of a bale bag support device system according to the present invention.

FIG. 3 is a representative perspective view of a bale bag support device according to the present invention.

FIG. 4 is a representative front view of a bale bag support device according to the present invention.

FIG. 5 is a representative top cutaway view of a bale bagging system according to the present invention.

FIG. 6 is a representative top cutaway view of a bale bagging system according to the present invention.

FIG. 7 is a representative top cutaway view of a bale bagging system according to the present invention.

FIG. 8 is a representative top cutaway view of a bale bagging system according to the present invention.

FIG. 9 is a representative top cutaway view of a bale bagging system according to the present invention.

FIG. 10 is a representative front view showing a plurality of bales bagged according to a method of the present invention.

FIG. 11 is a representative front view showing a plurality of bales bagged according to a method of the present invention.

### DETAILED DESCRIPTION

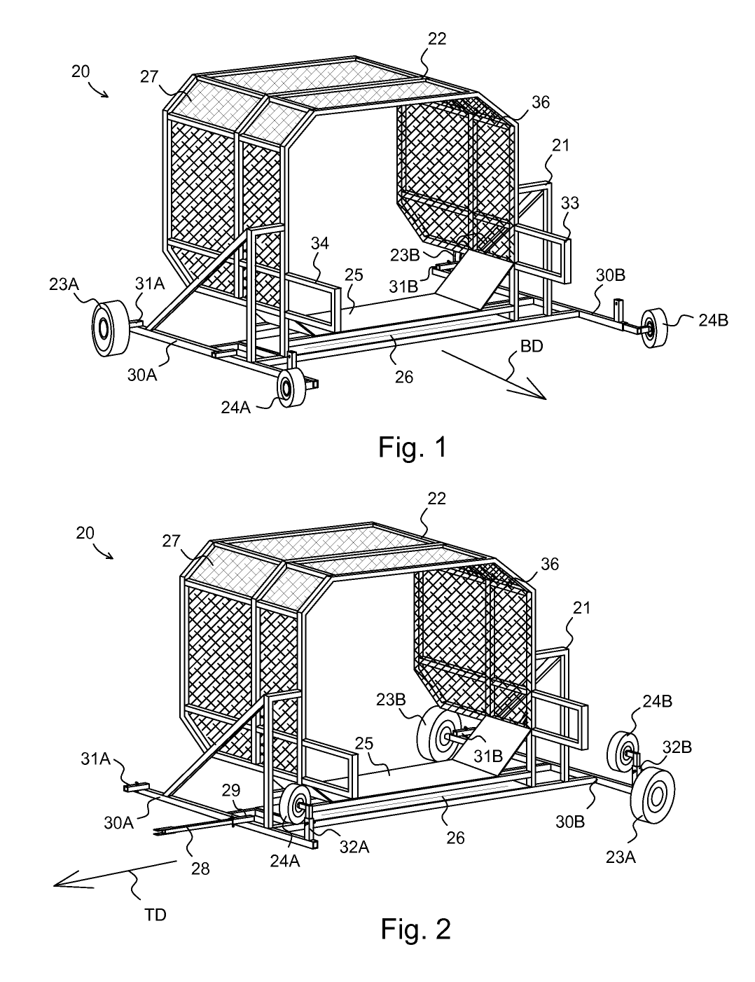

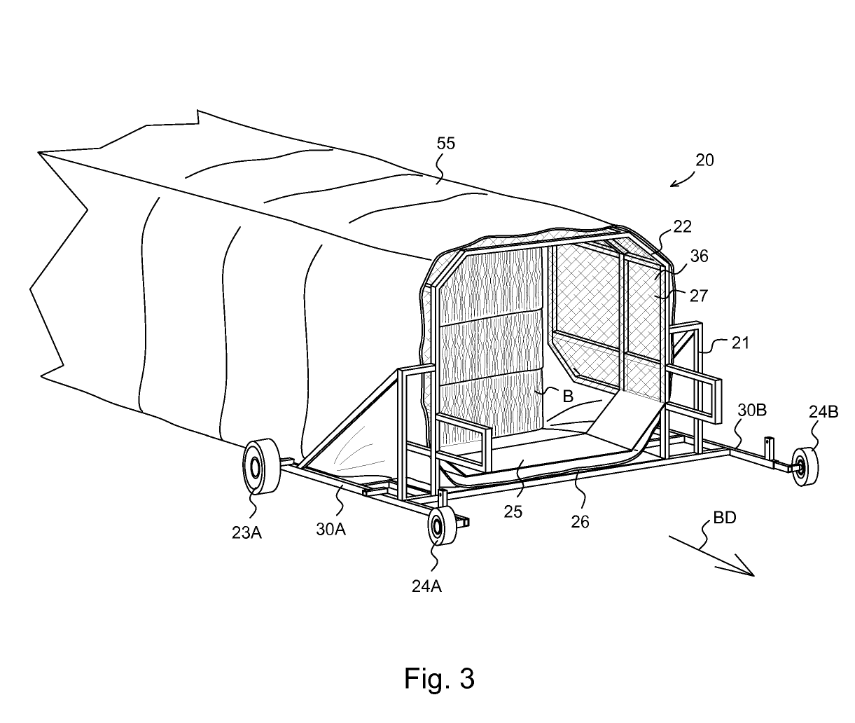

Referring to FIGS. 1 through 3, a preferred embodiment of bale bag support device 20 is shown to advantage. Frame 21 is shown supported by and movable on first rear wheel assembly 23A, (seen in FIGS. 1 through 3), connected to first cross member 30A, second rear wheel assembly 23B, (seen in FIGS. 1 and 2), connected to second cross member 30B and first and second leading wheel assemblies 24A and 24B, (seen in FIGS. 1 through 3) connected to first and second cross members 30A and 30B respectively. Frame 21 in turn supports bag support frame 22 about which bale bag 55, (seen in FIG. 3), may be placed. Referring to FIGS. 1 through 3, bag support tray 26 is attached to frame 21 and is located below bale threshold 25. Bag support frame 22 and bale threshold 25 define bale aperture 36 through which bale B may be introduced into bale bag 55 as seen in FIG. 3.

Referring to FIG. 1, bale bag support device 20 is configured for travel in a direction indicated generally by vector BD for bagging bales. In the preferred embodiment of the invention, leading wheel assemblies 24A and 24B are removably attached to frame 21 in a first leading wheel assembly orientation and rear wheel assemblies 23A and 23B are removably attached to frame 21 in a first rear wheel assembly orientation, as shown in FIG. 1. More particularly, rear wheel assembly 23A is removably attached to first rear wheel assembly receiver 31A, which is connected to first cross member 30A. In similar fashion, rear wheel assembly 23B is removably attached to second rear wheel assembly receiver 31B that is connected to second cross member 30B. Leading wheel assembly 24A is removably attached at a first end of first cross member 30A while leading wheel assembly 24B is removably attached at a first end of second cross member 30B. In the preferred embodiment of the invention, frame 21 includes a pair of pull bars 33 and 34 which may be engaged by a locomotion device, (not shown in FIGS. 1-3), that is capable of providing a motive force to advance bale bag support device 20 in a direction indicated generally by vector BD for bagging bales.

Referring to FIG. 2, bale bag support device 20 is configured for travel in a direction indicated generally by vector TD for transporting bale bag support device 20 to or from locations where bagging activities may occur. Rear wheel assemblies 23A and 23B are removably attachable to the frame in a second rear wheel assembly orientation, as shown in FIG. 2 to facilitate advancing motion of frame 21 along vector TD defining a transport direction. In this configuration, rear wheel assembly 23A is removably attached at the first end of second cross member 30B, while rear wheel assembly 23B is removably attached at a second end of second cross member 30B. In the preferred embodiment of the invention, leading wheel assembly 24A is inserted in first stub receiver 32A while leading wheel assembly 24B is inserted in second stub receiver 32B. In the transport configuration, shown FIG. 2, tow bar 28 is removably connected to tow bar receiver 29.

Referring to FIG. 3, bale bag support device 20 is configured for travel in a direction indicated generally by vector BD for bagging bales. Bale bag 55 is supported by bag support screen 27, which is attached to bag support frame 22, and bag support tray 26 which is located beneath bale threshold 25 and attached to frame 21. Bales B are loaded into bale bag 55 by a loader, (not shown).

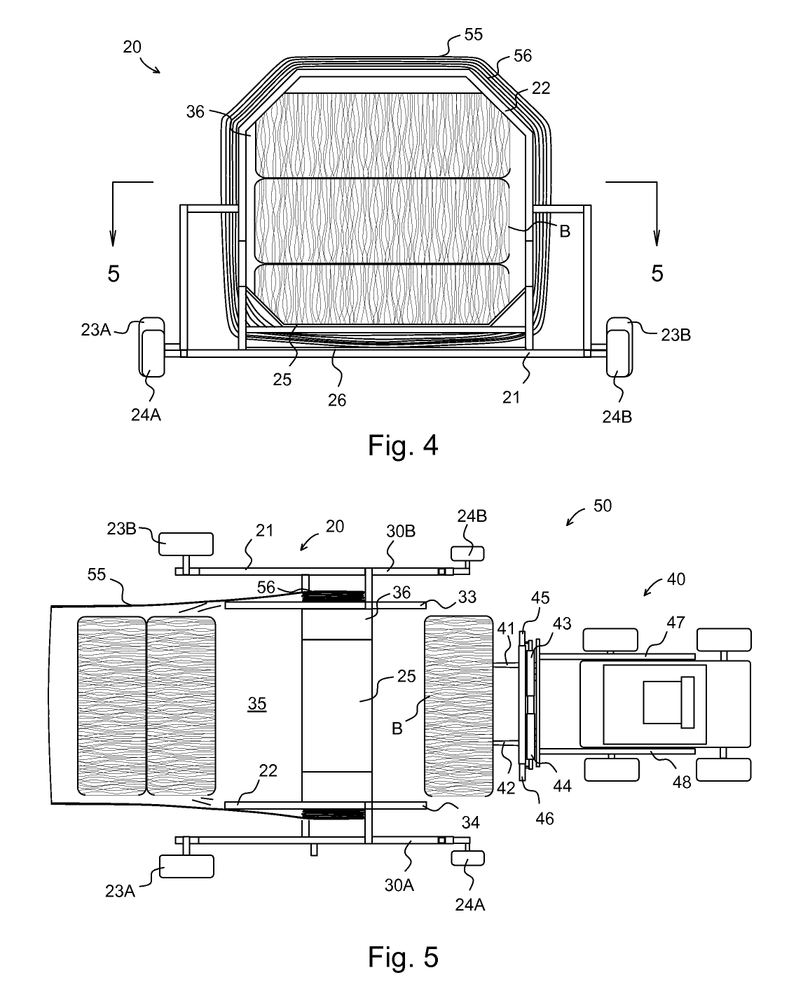

FIG. 4 shows a front view of bale bag support device 20. Bale bag support device 20 is shown including frame 21 which is shown supported by and movable on first and second rear wheel assemblies 23A and 23B and first and second leading wheel assemblies 24A and 24B. Frame 21 supports bag support frame 22 and bag support tray 26 is attached to frame 21 and is located below bale threshold 25. Bale bag 55 is placed about and is supported by bag support frame 22 passing below bale threshold 25 being supported below by bag support tray 26. Bale bag 55 is arranged having accordion folds 56 that unfold as bale bag support device 20 advances.

Referring to FIGS. 5 through 9, operation of bale bagging system 50 will be described. As shown, bale bag support device 20 includes frame 21 which is supported by and movable on first rear wheel assembly 23A and first leading wheel assembly 24A connected to first cross member 30A and second rear wheel assembly 23B and second leading wheel assembly 24B connected second cross member 30B. Frame 21 supports bag support frame 22 about which bale bag 55 is positioned. Bale bag 55 is arranged having accordion folds 56 that unfold as bale bag support device 20 advances. First and second pull bars 33 and 34 are connected to and extend from frame 21. Bale bagging system 50 also includes lift 40 that in the preferred embodiment of the invention is employed to pick and place bales B over bale threshold 25 onto bale receiving area 35 located just behind bale threshold 25 and within bale bag 55. Lift 40 includes forks 41 and 42 connected to hydraulically actuated lift arms 47 and 48. Lift 40 also includes a pair of slide arms 45 and 46 that extend and retract laterally by action of hydraulic rams 43 and 44.

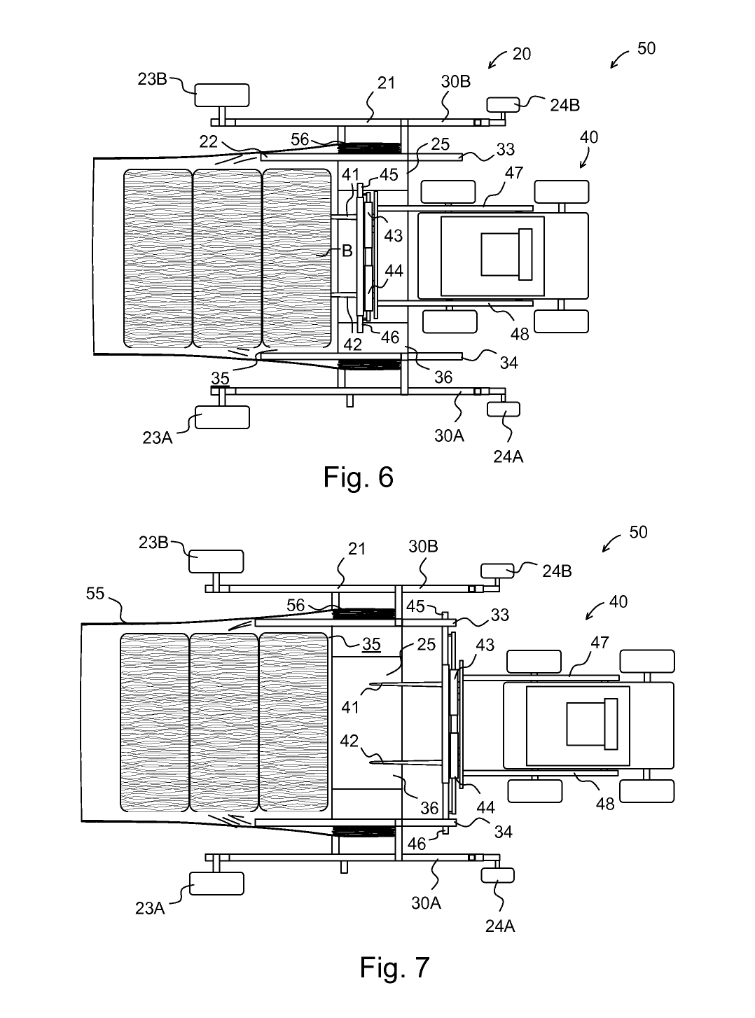

Referring to FIG. 5, lift 40 has picked bale B and moves between pull bars 33 and 34 to lift bale B over bale threshold 25. As shown in FIG. 6, lift 40 has lifted bale B over bale threshold 25 and positioned bale B above bale receiving area 35. Depending on the size of the bales being inserted into bale bag 55, bales may be stacked one on top of another as seen in FIG. 3. Alternately round baled may be inserted endwise into bale bag 55 employing the means and methods of the present invention.

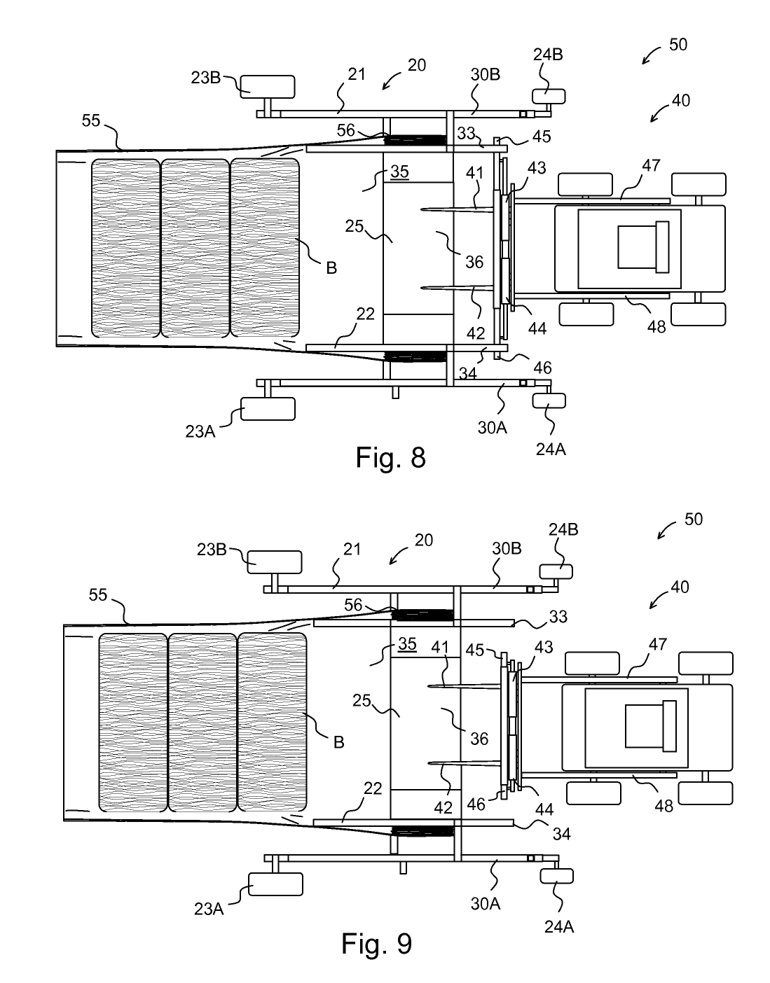

Referring to FIG. 7, lift 40 has reversed and hydraulic rams 43 and 44 have extended so that slide arms 45 and 46 engage first and second pull bars 33 and 34. As lift 40 continues to reverse, bale bag support device 20 advances pulling an appropriate length of bale bag 55 from accordion folds 56 as shown in FIG. 8 to create a new bale receiving area 35 behind bale threshold 25. Referring to FIG. 9, once lift 40 has reversed far enough to create a distance between an inner edge of bale threshold 25 and the face of the forward-most bale B slightly greater than a depth of bale B, hydraulic rams 43 and 44 retract and slide arms 45 and 46 are withdrawn from first and second pull bars 33 and 34 so that lift 40 is free to move away from bale bag support device 20 to retrieve another bale.

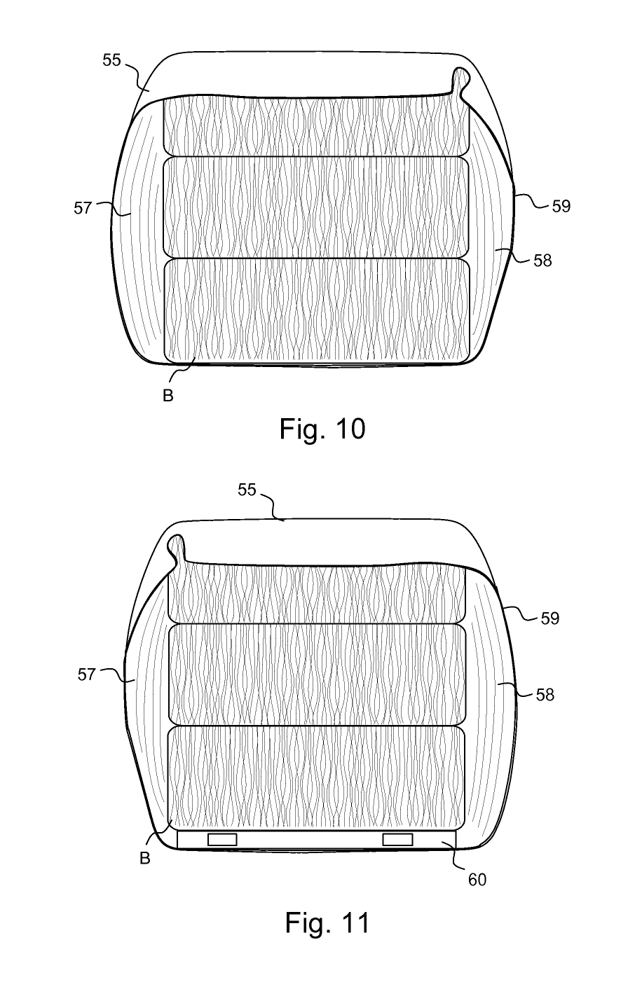

Referring to FIGS. 10 and 11, in the preferred embodiment of the invention, bale bag 55 is sized having a girth 59 that is ample enough such that when bales B are positioned within bale bag 55 air passages 57 and 58 are created on either side of bales B to permit passage of air through the length of the interior of bale bag 55 to aid in drying the baled material. It has been observed that when the ends of bale bag 55 are left substantially opened as shown in FIGS. 10 and 11 and the bale bag 55 is sized with respect to the bales as previously discussed there is a natural tendency for a draft to be created through bale bag 55 across the exposed surfaces of the bagged bales to facilitate the removal of moisture from the baled material. Referring to FIG. 11, in an alternate preferred method of the invention, bales B are place on pallets 60 to further facilitate the movement of air through bale bag 55.

It should be noted that while FIGS. 3-11 depict bales B having a rectangular configuration, bale bag support device 20 and the method of the present invention are adaptable as well to baled material having a variety of configurations, for example round or square bales.

The preceding description of the illustrated embodiments has been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Process steps described might be interchangeable with other steps in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, or method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . . ”

What is claimed is:

1. A bale bag support device for facilitating placement of a bale into a bale bag for storage on a surface, the bale bag support device comprising:
a frame adapted for advancing motion with respect to the surface;
a bag support attached to the frame, the bag support configured to support the bale bag in an opened configuration;
a bale threshold attached to the frame;
a bale receiving area located on an inner surface of the bale bag beyond the bale threshold; and
the bag support and the bale threshold defining an aperture through which the bale is placed into the bale bag.

2. The bale bag support device of claim 1 wherein the frame further comprises one or more wheels attached to the frame and configured to facilitate advancing motion with respect to the surface.

3. The bale bag support device of claim 1 wherein the frame further comprises a pair of leading wheel assemblies attached to the frame and a pair of rear wheel assemblies attached to the frame, the leading wheel assemblies and the rear wheel assemblies configured to facilitate advancing motion of the frame with respect to the surface along a vector defining a bagging direction.

4. The bale bag support device of claim 1 wherein the frame further comprises a pair of leading wheel assemblies removably attached to the frame in a first leading wheel assembly orientation and a pair of rear wheel assemblies removably attached to the frame in a first rear wheel assembly orientation, the leading wheel assemblies and the rear wheel assemblies configured to facilitate advancing motion of the frame with respect to the surface along a vector defining a bagging direction when the leading wheel assemblies are attached in the first leading wheel assembly orientation and the rear wheel assemblies are attached in the first rear wheel assembly orientation and the pair of rear wheel assemblies removably attachable to the frame in a second rear wheel assembly orientation, the rear wheel assemblies configured to facilitate advancing motion of the frame with respect to the surface along a vector defining a transport direction.

5. The bale bag support device of claim 1 wherein the frame further comprises a pull bar attached to the frame, the pull bar adapted to engage a locomotion device capable of providing a motive force for advancing the frame.

6. The bale bag support device of claim 1 wherein the frame further comprises a pair of pull bars attached to the frame, the pair of pull bars adapted to engage a locomotion device capable of providing a motive force for advancing the frame.

7. The bale bag support device of claim 1 further comprising a tow bar receiver attached to the frame and a tow bar removably connected to the tow bar receiver.

8. A bale bagging system for bagging a bale for storage on a surface, the bale bagging system comprising:
a bale bag support device including a frame adapted for advancing motion with respect to the surface;
a bag support attached to the frame, the bag support configured to support the bale bag in an opened configuration;
a bale threshold attached to the frame;
a bale receiving area located on an inner surface of the bale bag beyond the bale threshold;
the bag support and the bale threshold defining a bale aperture; and
a pick and place device adapted to pick the bale and place the bale through the bale aperture into the bag.

9. The bale bagging system of claim 8 wherein the frame further comprises one or more wheels attached to the frame and configured to facilitate advancing motion with respect to the surface.

10. The bale bagging system of claim 8 wherein the frame further comprises a pair of leading wheel assemblies attached to the frame and a pair of rear wheel assemblies attached to the frame, the leading wheel assemblies and the rear wheel assemblies configured to facilitate advancing motion of the frame with respect to the surface along a vector defining a bagging direction.

11. The bale bagging system of claim 8 wherein the frame further comprises a pair of leading wheel assemblies removably attached to the frame in a first leading wheel assembly orientation and a pair of rear wheel assemblies removably attached to the frame in a first rear wheel assembly orientation, the leading wheel assemblies and the rear wheel assemblies configured to facilitate advancing motion of the frame with respect to the surface along a vector defining a bagging direction when the leading wheel assemblies are attached in the first leading wheel assembly orientation and the rear wheel assemblies are attached in the first rear wheel assembly orientation and the pair of rear wheel assemblies removably attachable to the frame in a second rear wheel assembly orientation, the rear wheel assemblies configured to facilitate advancing motion of the frame with respect to the surface along a vector defining a transport direction.

12. The bale bagging system of claim 8 wherein the frame further comprises a pull bar attached to the frame, the pull bar adapted to engage a locomotion device capable of providing a motive force for advancing the frame.

13. The bale bagging system of claim 8 wherein the frame further comprises a pair of pull bars attached to the frame, the pair of pull bars adapted to engage a locomotion device capable of providing a motive force for advancing the frame.

14. The bale bagging system of claim 8 further comprising a tow bar receiver attached to the frame and a tow bar removably connected to the tow bar receiver.

15. The bale bagging system of claim 8 wherein the pick and place device further comprises a lift including one or more tines adapted to penetrate the bale, one or more lifting arms adapted to pick the bale and place the bale through the bale aperture into the bag.

16. The bale bagging system of claim 12 wherein the pick and place device further comprises a lift including one or more tines adapted to penetrate the bale, one or more lifting arms adapted to pick the bale and place the bale through the bale aperture into the bale bag and a slide arm adapted to extend and retract to engage the pull bar.

17. The bale bagging system of claim 13 wherein the pick and place device further comprises a lift including one or more tines adapted to penetrate the bale, one or more lifting arms adapted to pick the bale and place the bale through the bale aperture into the bale bag and a pair of slide arms adapted to extend and retract to engage the pair of pull bars.

18. A method for facilitating placement of a bale into a bale bag for storage on a surface, the method including the steps of:
maintaining a bale bag in an opened configuration employing a bale bag support device that includes a frame, a bag support attached to the frame and a bale threshold attached to the frame, the bag support and the bale threshold defining a bale aperture; and
picking and placing the bale in the bale bag onto a bale receiving area located on an inner surface of the bale bag beyond the bale threshold.

19. The method of claim 18 further including the step of engaging the bale bag support device with a pick and place device and advancing the bale bag support device a distance sufficient to create a bale receiving area located on an inner surface of the bale bag beyond the bale threshold.

20. The method of claim 18 further including the step of creating an air passage along a side of the bale following placement in the bale bag to permit passage of air through an interior of the bale bag to aid in drying the bale.
